(19) United States
(12) Patent Application Publication
(10) Pub. No.: US 2024/0046622 A1
(43) Pub. Date: Feb. 8, 2024

(54) INFORMATION PROCESSING APPARATUS, INFORMATION PROCESSING SYSTEM, INFORMATION PROCESSING METHOD, AND PROGRAM

(71) Applicant: SONY GROUP CORPORATION, TOKYO (JP)

(72) Inventor: TOMONORI TSUTSUMI, TOKYO (JP)

(21) Appl. No.: 18/255,882

(22) PCT Filed: Nov. 11, 2021
(86) PCT No.: PCT/JP2021/041456

§ 371 Date: Jun. 5, 2023

(30) Foreign Application Priority Data
Dec. 15, 2020 (JP) 2020-207791

(51) Int. Cl. G06V 10/776; G06V 20/50; G06V 10/778

(52) U.S. Cl. CPC G06V 10/776; G06V 20/50; G06V 10/7792

(57) ABSTRACT

An information processing apparatus (100) includes a generation unit (132), a conversion unit (133), an evaluation unit (134), an image analysis unit (135), and a determination unit (138). The generation unit (132) performs supervised learning using first image data and teacher data and generates an image conversion model. The conversion unit (133) generates converted data from the second image data using the image conversion model. The evaluation unit (134) evaluates the converted data. The image analysis unit (135) analyzes second image data corresponding to the converted data, evaluation of which by the evaluation unit (134) is lower than a predetermined standard. The determination unit (138) determines, based on an analysis result by the image analysis unit (135), a photographing environment of photographing performed to acquire teacher data.

### FIELD

The present disclosure relates to an information processing apparatus, an information processing system, an information processing method, and a program.

### BACKGROUND

There is a technology for imaging recognition using a supervised machine learning method. In such a technology, recognition accuracy can be improved by using a larger number of learning data sets. By extending one piece of image data using the Data Augmentation technology, the number of such learning data sets can be increased. For example, a method of extending image data by cropping for cutting a partial area of an image has been known.

### CITATION LIST

### Patent Literature

Patent Literature 1: JP 2020-177486 A

### SUMMARY

### Technical Problem

In the Data Augmentation technology, one piece of image data is extended. A basic image pattern is the same as an original image. Therefore, it is likely that data contributing to improvement of learning accuracy cannot be obtained.

Therefore, the present disclosure proposes an information processing apparatus, an information processing system, an information processing method, and a program that can obtain learning data more contributing to improvement of learning accuracy.

Note that the above problem or subject is merely one of a plurality of problems or subjects that can be solved or achieved by a plurality of embodiments disclosed in the present specification.

### Solution to Problem

According to the present disclosure, an information processing apparatus is provided. The information processing apparatus includes a generation unit, a conversion unit, an evaluation unit, an image analysis unit, and a determination unit. The generation unit performs supervised learning using first image data and teacher data and generates an image conversion model. The conversion unit generates converted data from the second image data using the image conversion model. The evaluation unit evaluates the converted data. The image analysis unit analyzes second image data corresponding to the converted data, evaluation of which by the evaluation unit is lower than a predetermined standard. The determination unit determines, based on an analysis result by the image analysis unit, a photographing environment of photographing performed to acquire teacher data.

### BRIEF DESCRIPTION OF DRAWINGS

FIG. 1 is a diagram for explaining an overview of an information processing system according to an embodiment of the present disclosure.

FIG. 2 is a diagram for explaining an overview of expansion processing according to the embodiment of the present disclosure.

FIG. 3 is a diagram illustrating a configuration example of the information processing system according to the embodiment of the present disclosure.

FIG. 4 is a table for explaining an example of attributes recognized by semantic segmentation.

FIG. 5 is a table for explaining an example of attributes recognized by semantic segmentation.

FIG. 6 is a diagram for explaining an example of an analysis using a dichroic reflection model.

FIG. 7 is a diagram for explaining an example of an analysis using a dichroic reflection model.

FIG. 8 is a diagram for explaining an example of the analysis using the dichroic reflection model.

FIG. 9 is a diagram for explaining an example of the analysis using the dichroic reflection model.

FIG. 10 is a diagram for explaining an example of the analysis using the dichroic reflection model.

FIG. 11 is a diagram for explaining an example of a composition analyzed by an image analysis unit according to the embodiment of the present disclosure.

FIG. 12 is a diagram for explaining an example of a composition analyzed by the image analysis unit according to the embodiment of the present disclosure.

FIG. 13 is a diagram for explaining an example of a composition analyzed by the image analysis unit according to the embodiment of the present disclosure.

FIG. 14 is a diagram for explaining an example of a composition analyzed by the image analysis unit according to the embodiment of the present disclosure.

FIG. 15 is a diagram for explaining motion estimation by a determination unit according to the embodiment of the present disclosure.

FIG. 16 is a diagram for explaining the motion estimation by the determination unit according to the embodiment of the present disclosure.

FIG. 17 is a diagram for explaining direction estimation for a light source by the determination unit according to the embodiment of the present disclosure.

FIG. 18 is a diagram for explaining the direction estimation for the light source by the determination unit according to the embodiment of the present disclosure.

FIG. 19 is a flowchart illustrating a flow of an example of evaluation expansion processing executed by the information processing apparatus according to the embodiment of the present disclosure.

FIG. 20 is a flowchart illustrating a flow of an example of lack expansion processing executed by the information processing apparatus according to the embodiment of the present disclosure.

FIG. 21 is a diagram for explaining another example of relearning by the information processing apparatus according to the embodiment of the present disclosure.

FIG. 22 is a hardware configuration diagram illustrating an example of a computer that implements functions of the information processing apparatus.

### DESCRIPTION OF EMBODIMENTS

An embodiment of the present disclosure is explained in detail below with reference to the accompanying drawings. Note that, in the present specification and the drawings, components having substantially the same functional configurations are denoted by the same reference numerals and signs, whereby redundant explanation of the components is omitted.

One or a plurality of embodiments (including examples and modifications) explained below can be respectively implemented independently. On the other hand, at least a part of the plurality of embodiments explained below may be implemented in combination with at least a part of other embodiments as appropriate. This plurality of embodiments can include new characteristics different from one another. Therefore, this plurality of embodiments can contribute to solving subjects or problems different from one another and can achieve different effects.

Note that the explanation is made in the following order.
1. Overview of an information processing system
1.1. Schematic configuration example of the information processing system
1.2. Problems
1.3. Overview of expansion processing
2. Configuration example of the information processing system
2.1. Imaging apparatus
2.2. Illumination apparatus
2.3. Information processing apparatus
3. Expansion processing
3.1. Evaluation expansion processing
3.2. Lack expansion processing
4. Other embodiments
5. Application examples
6. Hardware configuration
7. Summary

### 1. Overview of an Information Processing System

### 1.1. Schematic Configuration Example of the Information Processing System

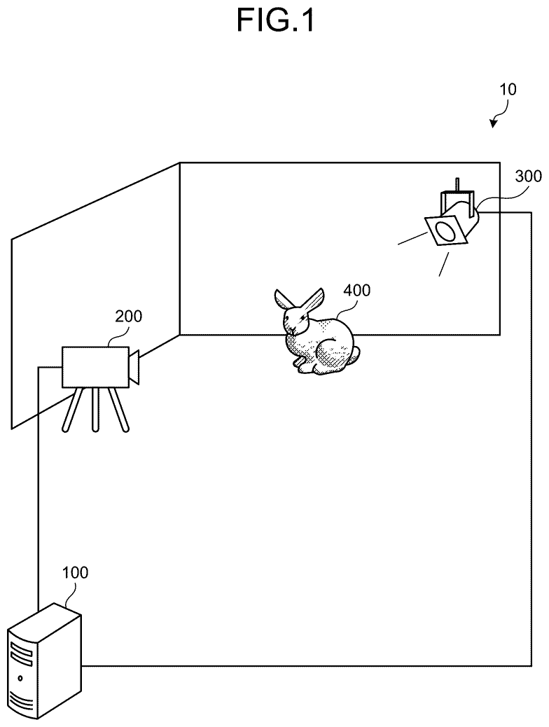

FIG. 1 is a diagram for explaining an overview of an information processing system 10 according to an embodiment of the present disclosure. As illustrated in FIG. 1, the information processing system 10 includes an information processing apparatus 100, an imaging apparatus 200, and an illumination apparatus 300.

[Information Processing Apparatus 100]

The information processing apparatus 100 is an apparatus that generates an image conversion model for performing image processing using machine learning. The information processing apparatus 100 generates an image conversion model with, for example, learning by DNN. The image conversion model is, for example, a model for performing image processing such as super-resolution processing and SDR-HDR conversion processing. The super-resolution processing is processing of converting an image into a higher-resolution image. The SDR-HDR conversion processing is processing of converting an SDR (Standard Dynamic Range) image, which is a conventional standard dynamic range, into a high dynamic range (HDR) image.

The information processing apparatus 100 performs supervised learning using a Ground Truth image (teacher data) and a deterioration image (student data) of the Ground Truth image and generates an image conversion model.

The information processing apparatus 100 controls the imaging apparatus 200 and the illumination apparatus 300 and images a subject 400 to acquire a Ground Truth image.

[Imaging Apparatus 200]

The imaging apparatus 200 is an apparatus that images the subject 400. The imaging apparatus 200 images the subject 400 according to an instruction from the information processing apparatus 100. The imaging apparatus 200 can capture an image equivalent to an image after conversion by an image conversion model such as a high resolution image or an HDR image.

[Illumination Apparatus 300]

The illumination apparatus 300 is an apparatus that irradiates the subject 400 with light when the imaging apparatus 200 images the subject 400. The illumination apparatus 300 performs lighting according to an instruction from the information processing apparatus 100.

Note that, in an example illustrated in FIG. 1, an example in which the imaging apparatus 200 and the illumination apparatus 300 are disposed in a studio is illustrated. However, the present disclosure is not limited thereto. As explained below, the imaging apparatus 200 only has to be able to capture a ground truth image. For example, the imaging apparatus 200 may be disposed outdoors to image a landscape or the like. In this case, the illumination apparatus 300 can be omitted.

### 1.2. Problems

Here, in machine learning (for example, DNN learning) by the information processing apparatus 100, the accuracy of image processing is improved as the number of pieces of learning data is larger. For example, an effect (accuracy) of the image processing can be obtained more as the number of patterns of the learning data is larger. However, a desired effect is not sometimes obtained with learning data including unlearned patterns and a small number of patterns.

As a method of obtaining a desired effect even with such patterns, there is a method of expanding learning data and increasing learned patterns. That is, by further collecting and learning data, the information processing apparatus 100 can generate a DNN model that can obtain a desired effect.

However, it is likely that a desired effect cannot be obtained simply by increasing the learning data. For example, when unlearned patterns or a small number of patterns are not included in recollected image data or the number of included patterns is small, it is likely that the information processing apparatus 100 cannot generate a DNN model that can obtain a desired effect even if the information processing apparatus 100 performs relearning using the learning data.

For example, conventionally, a method of performing Data Augmentation to increase learning data has been known. However, the Data Augmentation is a technique for extending one piece of image data. A basic image pattern is almost the same as that of original image data. Therefore, even if the information processing apparatus 100 performs data augmentation on already learned learning data and collects learning data, it is likely that a DNN model (an image conversion model) generated by relearning cannot obtain a desired effect.

Similarly, even if the information processing apparatus 100 processes and generates already learned learning data and collects new learning data, it is likely that a DNN model generated by relearning cannot obtain a desired effect.

In contrast, by increasing the number of pieces of learning data to be collected again, the information processing apparatus 100 can acquire learning data of many patterns. However, in this case, as the number of pieces of learning data increases, an enormous time is required for subsequent relearning. In particular, when learning data is a moving image, a learning time greatly increases.

Since the information processing apparatus 100 performs supervised learning, it is difficult to generate a DNN model with learning using general image data without a Ground Truth image. When there is only a small number of images to be Ground Truth images, it is likely that the information processing apparatus 100 cannot collect learning data necessary for relearning.

In this manner, it is requested to expand learning data that contributes to improvement of accuracy of image processing by the information processing apparatus 100.

Therefore, in an embodiment of the present disclosure, the information processing apparatus 100 collects, using the imaging apparatus 200, learning data (image data) that contributes to improvement of accuracy of image processing. For example, the information processing apparatus 100 analyzes converted data subjected to image conversion using a generated DNN model and determines information concerning an image to be collected. Consequently, the imaging apparatus 200 can capture an image based on the determined information. The information processing apparatus 100 can collect the captured image. As a result, the information processing apparatus 100 can expand the learning data that contributes to improvement of accuracy of image processing.

### 1.3. Overview of Expansion Processing

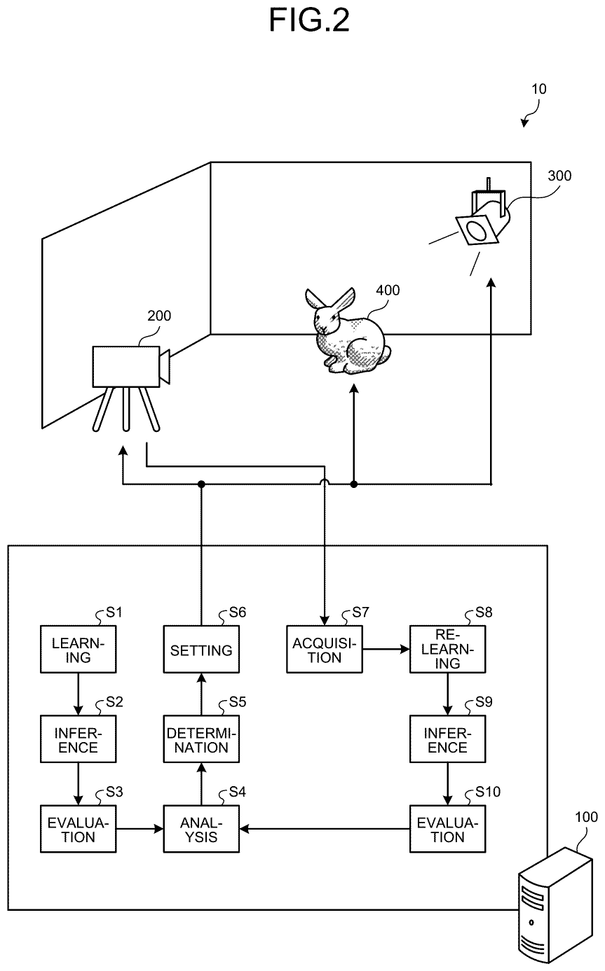

FIG. 2 is a diagram for explaining an overview of an expansion processing according to the embodiment of the present disclosure.

First, the information processing apparatus 100 acquires a learning data set and learns an image conversion model (step S1). Subsequently, the information processing apparatus 100 performs image processing for general image data without a Ground Truth image using the learned image conversion model to infer image data (step S2).

The information processing apparatus 100 evaluates the inferred image data (step S3) and analyzes image data with low evaluation (step S4). The information processing apparatus 100 compares, for example, an evaluation value with a predetermined threshold, performs an image analysis on image data with low evaluation, and detects motions and lighting information of a camera and a subject, object information of the subject, a scene, and the like.

The information processing apparatus 100 determines, based on an image analysis result, an imaging environment in which a Ground Truth image is captured (step S5). The information processing apparatus 100 sets, for example, a type of the subject 400, and control parameters of the imaging apparatus 200 and the illumination apparatus 300 to determine an imaging environment.

The information processing apparatus 100 sets the determined imaging environment (step S6). For example, the information processing apparatus 100 presents information concerning setting for the subject 400 to a user and notifies the control parameters of the imaging apparatus 200 and the illumination apparatus 300 to the imaging apparatus 200 and the illumination apparatus 300. For example, the user disposes the subject 400, the information concerning the setting for which is presented, in a predetermined position.

Consequently, the imaging apparatus 200 can image the subject 400 in the determined imaging environment. The information processing apparatus 100 can acquire a Ground Truth image captured by the imaging apparatus 200.

The information processing apparatus 100 acquires an image captured by the imaging apparatus 200 (step S7). The information processing apparatus 100 performs relearning using the acquired captured image as a Ground Truth image (teacher data) and using an image obtained by deteriorating the captured image as student data (S8).

The information processing apparatus 100 the information processing apparatus 100 performs image processing for general image data without a Ground Truth image using the relearned image conversion model to infer image data (step S9). The information processing apparatus 100 evaluates the inferred image data (step S10).

When there is image data with low evaluation, the information processing apparatus 100 returns to step S4 and analyzes the image data with low evaluation. On the other hand, when there is no image data with low evaluation, the information processing apparatus 100 ends the expansion processing.

By determining the imaging environment based on the analysis result of the image data, for which desired accuracy cannot be obtained, in this way, the information processing apparatus 100 can acquire a captured image having an image pattern similar to the image data. Consequently, the information processing apparatus 100 can acquire a captured image that can further contribute to accuracy improvement and can more efficiently expand learning data.

The information processing apparatus 100 repeatedly performs the expansion processing including the image analysis and the determination of an imaging environment until a desired evaluation is obtained. Consequently, the information processing apparatus 100 can further improve the accuracy of the image conversion model.

Note that, here, the information processing apparatus 100 sets the control parameters for the imaging apparatus 200 and the illumination apparatus 300. However, the present disclosure is not limited thereto. For example, the information processing apparatus 100 may notify the determined control parameter to an external apparatus (not illustrated) or the user and performs setting for the imaging apparatus 200 and the illumination apparatus 300.

Here, the user performs the setting for the subject 400. However, the present disclosure is not limited thereto. For example, a conveyance apparatus such as a robot or a belt conveyor may perform setting such as selection and disposition of the subject 400.

Note that, here, a case in which the information processing apparatus 100 generates an image conversion model for performing super-resolution processing and SDR-HDR conversion processing is explained as an application example of the technique of the present disclosure. However, image processing using the image conversion model is not limited thereto. The image processing may be any processing if the image processing is image processing using an image conversion model generated by machine learning.

### 2. Configuration Example of the Information Processing System

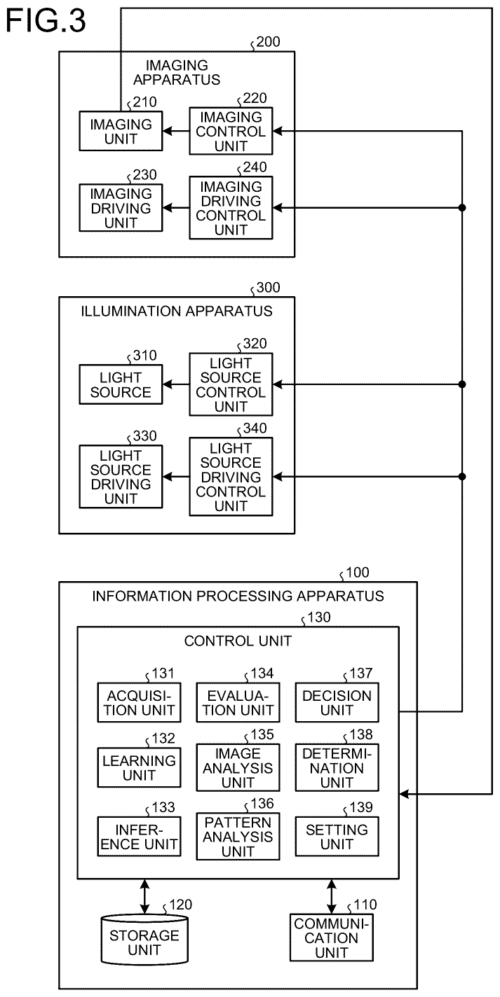

A configuration example of the apparatuses of the information processing system 10 according to the embodiment of the present disclosure is explained with reference to FIG. 3. FIG. 3 is a diagram illustrating a configuration example of the information processing system 10 according to the embodiment of the present disclosure.

### 2.1. Imaging Apparatus

As illustrated in FIG. 3, the imaging apparatus 200 includes an imaging unit 210, an imaging control unit 220, an imaging driving unit 230, and an imaging driving control unit 240.

[Imaging Unit 210]

The imaging unit 210 images the subject 400 to generate a captured image. The imaging unit 210 is, for example, an image sensor. The imaging unit 210 captures and generates, for example, a high-resolution captured image or an HDR image. The imaging unit 210 captures and generates, for example, a moving image or a still image. The imaging unit 210 outputs the captured image to the information processing apparatus 100.

[Imaging Control Unit 220]

The imaging control unit 220 controls the imaging unit 210 based on imaging setting information notified from the information processing apparatus 100. The imaging setting information includes control parameters concerning imaging conditions of the imaging unit 210 such as shutter speed, an aperture value, and ISO sensitivity.

[Imaging Driving Unit 230]

The imaging driving unit 230 causes units of the imaging apparatus 200 related to adjustment of pan, tilt, and zoom such as a camera platform, on which the imaging apparatus 200 is placed, to operate. Specifically, the imaging driving unit 230 operates a zoom lens of an optical system of the imaging unit 210, the camera platform, and the like under the control of the imaging driving control unit 240 explained below and changes the position and the posture of the imaging apparatus 200.

[Imaging Driving Control Unit 240]

The imaging driving control unit 240 controls the imaging driving unit 230 based on imaging driving setting information notified from the information processing apparatus 100. The imaging driving setting information includes information for instructing a motion of the imaging apparatus 200.

Note that, when the user receives a completion notification indicating that the setting for the subject 400 is completed, the imaging driving control unit 240 may drive the imaging driving unit 230 to obtain a composition designated by the information processing apparatus 100. In this case, the imaging driving control unit 240 analyzes a captured image captured by the imaging unit 210 and controls the imaging driving unit 230 to obtain a predetermined composition. Note that the completion notification may be received from the information processing apparatus 100 or may be directly received from the user.

### 2.2. Illumination Apparatus

As illustrated in FIG. 3, the illumination apparatus 300 includes a light source 310, a light source control unit 320, a light source driving unit 330, and a light source driving control unit 340.

[Light Source 310]

The light source 310 is, for example, an LED (Light Emitting Diode) and irradiates the subject 400 with light according to control by the light source control unit 320.

[Light Source Control Unit 320]

The light source control unit 320 controls the light source 310 based on light source setting information notified from the information processing apparatus 100. The light source setting information includes control parameters concerning light emission conditions for the light source 310 such as light intensity and a color.

[Light Source Driving Unit 330]

The light source driving unit 330 operates each unit of the illumination apparatus 300 related to adjustment of pan and tilt. Specifically, the light source driving unit 330 changes the position and the posture of the illumination apparatus 300 according to control of the light source driving control unit 340 explained below.

[Light Source Driving Control Unit 340]

The light source driving control unit 340 controls the light source driving unit 330 based on light source driving setting information notified from the information processing apparatus 100. The light source driving setting information includes information for instructing a motion of the illumination apparatus 300.

Note that imaging and light emission can be performed in synchronization with the imaging apparatus 200 and the illumination apparatus 300. In this case, the imaging apparatus 200 and the illumination apparatus 300 may directly communicate with each other or may communicate with each other via the information processing apparatus 100.

### 2.3. Information Processing Apparatus

As illustrated in FIG. 3, the information processing apparatus 100 includes a communication unit 110, a storage unit 120, and a control unit 130.

[Communication Unit 110]

The communication unit 110 is a communication interface that communicates with an external apparatus via a network by wire or radio. The communication unit 110 is implemented by, for example, an NIC (Network Interface Card).

[Storage Unit 120]

The storage unit 120 is a data readable/writable storage device such as a DRAM, an SRAM, a flash memory, or a hard disk. The storage unit 120 functions as storage means of the information processing apparatus 100. The storage unit 120 stores a learning coefficient of an image conversion model generated by the control unit 130 explained below, a learning data set used for learning of the image conversion model, and the like.

[Control Unit 130]

The control unit 130 controls the units of the information processing apparatus 100. The control unit 130 is implemented by a program stored inside the information processing apparatus 100 being executed by a CPU (Central Processing Unit), an MPU (Micro Processing Unit), or the like using a RAM (Random Access Memory) or the like as a work area. The control unit 130 is implemented by an integrated circuit such as an ASIC (Application Specific Integrated Circuit) or an FPGA (Field Programmable Gate Array).

The control unit 130 includes an acquisition unit 131, a learning unit 132, an inference unit 133, an evaluation unit 134, an image analysis unit 135, a pattern analysis unit 136, a decision unit 137, a determination unit 138, and a setting unit 139.

(Acquisition Unit 131)

The acquisition unit 131 acquires learning data to be used in learning by the learning unit 132. The acquisition unit 131 acquires, for example, a learning data set to be stored in the storage unit 120. Alternatively, the acquisition unit 131 may acquire, via the communication unit 110, a learning data set to be stored in an external apparatus.

The acquisition unit 131 acquires learning data to be used in relearning by the learning unit 132. The acquisition unit 131 acquires, for example, a captured image captured by the imaging apparatus 200 as learning data.

The acquisition unit 131 acquires a test image (an example of second image data) used when the inference unit 133 performs inference. The test image is a general image without a Ground Truth image and is an image corresponding to a deteriorated image used for learning in the learning unit 132.

The acquisition unit 131 outputs the acquired learning data to the learning unit 132 and outputs an inference image to the inference unit 133.

(Learning Unit 132)

The learning unit 132 is a generation unit that performs learning for image processing such as super-resolution and SDR-HDR conversion using the learning data acquired by the acquisition unit 131 and generates an image conversion model.

In the following explanation, learning performed for the first time by the learning unit 132 is referred to as initial learning and is distinguished from relearning performed for the second and subsequent times using the imaging apparatus 200.

When the initial learning is performed, the learning unit 132 performs supervised learning using a Ground Truth image (teacher data) included in the learning data set acquired by the acquisition unit 131 and a deteriorated image (an example of first image data, student data) of the Ground Truth image. Note that, when the acquisition unit 131 acquires the Ground Truth image, the learning unit 132 may generate a deteriorated image obtained by deteriorating the Ground Truth image and perform learning using the Ground Truth image acquired by the acquisition unit 131 and the generated deteriorated image.

When performing relearning, the learning unit 132 performs learning using the captured image acquired by the acquisition unit 131 from the imaging apparatus 200 in addition to the learning data set used in the initial learning. More specifically, the learning unit 132 generates an imaged data set using the captured image as teacher data and using a captured deteriorated image obtained by deteriorating the captured image as student data. The learning unit 132 adds the imaging data set to the learning data set used in the initial learning and performs the supervised learning again.

The learning unit 132 outputs the generated image conversion model to the inference unit 133. Note that the image conversion model generated by the initial learning is also referred to as initial conversion model and the image conversion model generated by the relearning is also referred to as reconversion model.

(Inference Unit 133)

The inference unit 133 is a conversion unit that generates, using the image conversion model, an inference image from a test image acquired by the acquisition unit 131. For example, the inference unit 133 uses the test image as an input of the image conversion model and obtains an inference image (an example of converted data) as an output of the image conversion model.

The inference unit 133 generates an inference image using the initial conversion model. The inference unit 133 generates an inference image using the reconversion model. Note that the inference image generated by the initial conversion model is also referred to as initial inference image and the inference image generated by the reconversion model is also referred to as re-inference image.

As explained above, the test image is a general deteriorated image having no corresponding Ground Truth image. Therefore, even when evaluation of an inference image by the evaluation unit 134 explained below is low and conversion accuracy is low, the information processing apparatus 100 is an image in which it is difficult to improve conversion accuracy by learning. Note that, in the proposed technique according to the present disclosure, the information processing apparatus 100 acquires a captured image similar to an inference image with low evaluation from the imaging apparatus 200 to improve conversion accuracy by learning.

(Evaluation Unit 134)

The evaluation unit 134 evaluates the inference image generated by the inference unit 133 and calculates an evaluation value. The evaluation unit 134 evaluates the inference image using PSNR (Peak Signal-to-Noise Ratio), SSIM (Structural Similarity), LPIPS (Learned Perceptual Image Patch Similarity), FID (Frechet Inception Distance), or MOS (Mean Opinion Score).

Here, the SSIM is an indicator indicating that similarity of an image structure contributes to sensing of human image quality degradation. The LPIPS is an indicator for evaluating diversity of a generated image (for example, an inference image). In LPIPS, an average feature distance of the generated image is measured.

The FID is an indicator for evaluating the quality of the generated image. In the FID, a distance between a generated image distribution and a real image (for example, test data) distribution is measured. The MOS is a subjective evaluation method and for example, a user performs evaluation. In the MOS, evaluation by the user is required but accuracy of the evaluation can be improved.

The evaluation unit 134 evaluates each of the initial inference image and the re-inference image and calculates an evaluation value. The evaluation value of the initial inference image is also referred to as initial evaluation value and the evaluation value of the re-inference image is also referred to as re-evaluation value.

The evaluation unit 134 outputs the calculated evaluation value to the decision unit 137.

(Decision Unit 137)

The decision unit 137 decides, based on the evaluation value, whether the learning unit 132 performs relearning. For example, the decision unit 137 compares the evaluation value with a predetermined threshold and decides whether evaluation of the inference image is low. When there is an inference image decided as having low evaluation, the decision unit 137 decides to perform the relearning by the learning unit 132. Alternatively, when the number of inference images decided as having low evaluation is larger than a predetermined number, the decision unit 137 may decide to perform the relearning.

The decision unit 137 decides to perform the relearning when there is a lacking pattern as a result of an analysis by the pattern analysis unit 136 explained below.

The decision unit 137 notifies a decision result to the units of the control unit 130. The decision unit 137 outputs information concerning the inference image (or the test image) with low evaluation to the image analysis unit 135.

(Image Analysis Unit 135)

The image analysis unit 135 analyzes various kinds of image information with respect to the test image with low evaluation. Note that, as explained above, the test image is an image deteriorated (for example, having a narrow dynamic range or low resolution) compared with the Ground Truth image. Since the image analysis unit 135 analyzes relatively large-scale information as explained below, the image analysis unit 135 can perform sufficient analysis even with such a deteriorated image (the test image).

(Motion Information)

The image analysis unit 135 detects, for example, a motion vector of the test image, which is a moving image, to analyze a motion of an imaging apparatus that has captured the test image and a motion of a subject imaged in the test image. As a result, the image analysis unit 135 generates motion information.

(Subject/Material Information)

The image analysis unit 135 executes semantic segmentation on the test image to thereby recognize attributes of the subject (an image region) imaged in the image.

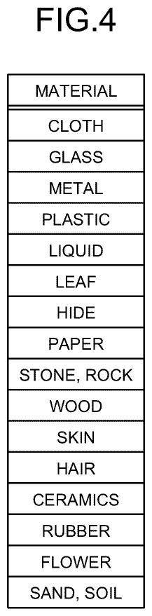

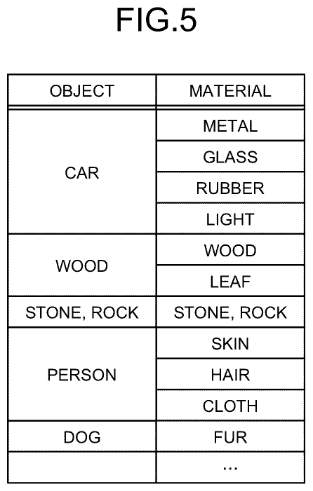

FIG. 4 and FIG. 5 are tables for explaining an example of attributes recognized by the semantic segmentation.

As illustrated in FIG. 4, the image analysis unit 135 by executes the semantic segmentation to recognize a material of the subject. Examples of the material recognized by the image analysis unit 135 include cloth, glass, metal, plastic, liquid, leaf, hide, paper, stone, stone and rock, wood, skin, hair, ceramics, rubber, flowers, sand and soil, and the like.

The image analysis unit 135 can recognize a subject imaged in an image according to a combination of recognized materials. For example, as illustrated in FIG. 5, when the recognized subject includes metal, glass, rubber, and light, the image analysis unit 135 recognizes that the subject (the object) is a car. Similarly, when the recognized subject includes trees and leaves, the image analysis unit 135 recognizes that the subject is a tree.

In this manner, the image analysis unit 135 generates the object (subject)/material information.

(Reflectance Information/Light Source Information of the Object)

The image analysis unit 135 analyzes reflectance information and light source information of the subject. For example, the image analysis unit 135 analyzes the reflectance of the subject, a color, intensity, a direction, and the like of the light source using a dichroic reflection model, DNN, or the like.

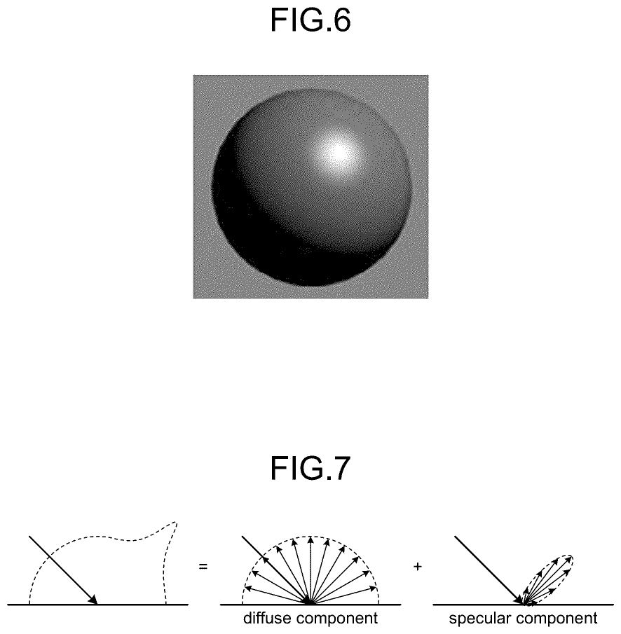

Here, an example of an analysis using the dichroic reflection model is explained with reference to FIG. 6 to FIG. 10. FIG. 6 to FIG. 10 are diagrams for explaining examples of the analysis using the dichroic reflection model.

In the following explanation, it is assumed that the image analysis unit 135 performs an analysis using the dichroic reflection model on an input image (for example, a test image) obtained by imaging a sphere illustrated in FIG. 6.

The dichroic reflection model is a model that assumes that reflected light illustrated in a left diagram of FIG. 7 includes a diffuse component illustrated in a middle diagram of FIG. 7 and a specular component illustrated in a right diagram of FIG. 7.

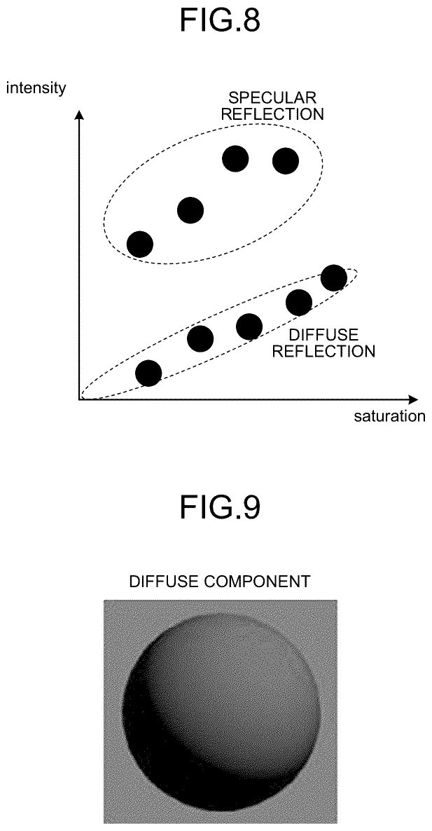

As illustrated in FIG. 8, the image analysis unit 135 maps distributions of saturation and intensity with respect to pixels of the input image. In FIG. 8, the horizontal axis represents saturation and the vertical axis represents intensity.

As illustrated in FIG. 8, the diffuse component is distributed substantially linearly. On the other hand, the specular component has higher intensity than the specular component and is distributed wider than the specular component.

Therefore, the image analysis unit 135 clusters and separates each of the diffuse component and the specular component.

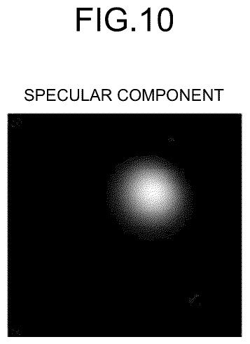

FIG. 9 is an image obtained by extracting the diffuse component from the input image (reflected light) illustrated in FIG. 6. FIG. 10 is an image obtained by extracting the specular component from the input image illustrated in FIG. 6.

As explained above, the image analysis unit 135 separates the specular component and the diffuse component on a color space using a difference in color occurring from a difference in reflectance, estimates the reflectance, and generates reflectance information. The image analysis unit 135 estimates a color, intensity, a direction, and the like of the light source and generates light source information.

Note that the image analysis unit 135 estimates reflectance and the like using a dichroic reflection model that assumes that a light source color is white. Therefore, for example, when a light source color is other than white, estimation accuracy is likely to decrease depending on a light source. Therefore, the image analysis unit 135 may estimate reflectance or the like using machine learning such as the DNN to suppress a decrease in estimation accuracy.

(Band/Luminance Histogram Information)

FIG. 3 is referred to again. The image analysis unit 135 calculates a band of the test image and generates band information. For example, the image analysis unit 135 can calculate a band of a partial region of the test image and generate local band information. The image analysis unit 135 can calculate a band of the entire test image and generate entire band information.

The image analysis unit 135 calculates luminance values of pixels of the test image and generates luminance distribution (luminance histogram) information of the image.

(Composition/Scene Information)

The image analysis unit 135 analyzes a composition of the test image using, for example, the DNN and generates composition information.

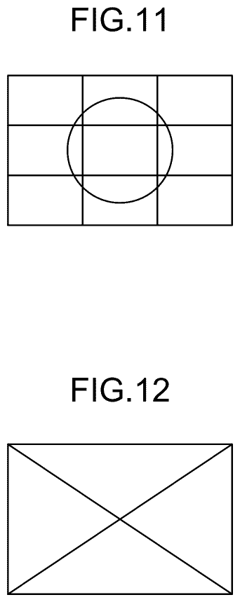

FIG. 11 to FIG. 14 are diagrams for explaining an example of a composition analyzed by the image analysis unit 135 according to the embodiment of the present disclosure.

As illustrated in FIG. 11, the image analysis unit 135 analyzes, using, for example, the DNN, whether the composition of the test image is a Hinomaru composition in which the subject is located in the center of the test image.

As illustrated in FIG. 12, the image analysis unit 135 analyzes, using, for example, the DNN, whether the composition of the test image is a diagonal composition. The diagonal composition is a composition in which a line is drawn diagonally from a corner of an image and a subject is arranged on the line.

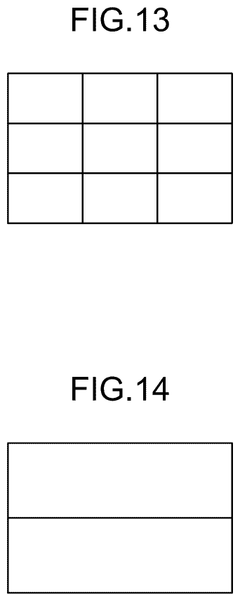

As illustrated in FIG. 13, the image analysis unit 135 analyzes, using, for example, the DNN, whether the composition of the test image is a three-division composition. The three-division composition is a composition in which lines are drawn to divide each of the length and the width of an image into three and a subject is arranged at an intersection of the lines or on the lines.

As illustrated in FIG. 14, the image analysis unit 135 analyze, using, for example, the DNN, whether the composition of the test image is a two-division composition. The two-division composition illustrated in FIG. 14 is a composition in which a line is drawn to divide the length of the image into two and a horizontal line such as a water surface or a ground surface is aligned on the line. Although FIG. 14 illustrates a two-division composition in which the image is vertically divided into two, the image may be horizontally divided into two.

Note that the composition analyzed by the image analysis unit 135 is not limited to the examples illustrated in FIG. 11 to FIG. 14. For example, the image analysis unit 135 can analyze various compositions such as a diagonal composition and a symmetric composition.

The image analysis unit 135 analyzes a scene of the test image using, for example, the DNN. The image analysis unit 135 detects, using, for example, the DNN, a scene of the test image, for example, whether the test image has been captured indoors (Indoor), in an outdoor landscape (Landscape), or in downtown (City).

(Depth of Field and Blur Information)

FIG. 3 is referred to again. The image analysis unit 135 analyzes the depth of field using Depth detection or the like and generates depth of field information and blur information. The image analysis unit 135 detects depth information of the test image using, for example, the DNN. The image analysis unit 135 performs foreground/background separation detection to separate a foreground and a background of the test image. The image analysis unit 135 estimates a depth of field and a blur degree using the detected depth information, the separated foreground, the separated background, band information, and the like.

(Noise Information)

The image analysis unit 135 performs noise detection on the test image, analyzes a noise amount, and generates noise information. For example, the image analysis unit 135 performs random noise detection on the test image.

Note that an analysis performed by the image analysis unit 135 is not limited to the analysis explained above. For example, the image analysis unit 135 may omit a part of the analysis such as analysis of a luminance histogram. For example, the image analysis unit 135 may perform an image analysis other than the analysis explained above.

The image analysis unit 135 outputs the generated kinds of information to the determination unit 138.

(Pattern Analysis Unit 136)

The pattern analysis unit 136 analyzes a learning data set used for initial learning (hereinafter also referred to as initial learning data set) and detects an image pattern lacking in the initial learning data set.

The pattern analysis unit 136 performs the same analysis as the analysis performed by the image analysis unit 135 on an image included in the initial learning data set. Note that the pattern analysis unit 136 may analyze a Ground Truth image included in the initial learning data set or may analyze a deteriorated image. Alternatively, the pattern analysis unit 136 may analyze both of the Ground Truth image and the deteriorated image.

The pattern analysis unit 136 classifies, using, for example, the DNN, for each of patterns, images included in the initial learning data set and detects that an image pattern in which the number of patterns is equal to or smaller than a predetermined number is a lacking image pattern.

Alternatively, the pattern analysis unit 136 classifies learning images included in the initial learning data set according to an analysis result and detects a lacking image pattern according to the number of classified images. For example, a case in which learning images are classified according to a result of the composition analysis is explained. For example, the pattern analysis unit 136 classifies the learning images for each of the detected compositions (for example, the Hinomaru composition, the diagonal composition, the three-division composition, the two-division composition, and the like, see FIG. 11 to FIG. 14). The pattern analysis unit 136 calculates numbers of learning images included in the compositions and detects a composition in which the calculated number is equal to or smaller than a predetermined number as a lacking composition (pattern).

Note that the pattern analysis unit 136 does not need to perform the same analysis as the analysis performed by the image analysis unit 135. For example, the pattern analysis unit 136 may perform, on the initial learning data set, a part of the analysis performed by the image analysis unit 135 and omit a part of the analysis. Alternatively, the pattern analysis unit 136 may perform, on the initial learning data set, an analysis not performed by the image analysis unit 135.

The pattern analysis unit 136 outputs presence or absence of a lacking image pattern to the decision unit 137. When receiving a notification to the effect that there is a lacking image pattern from the pattern analysis unit 136, the decision unit 137 decides to perform relearning of the image conversion model.

In addition, the pattern analysis unit 136 outputs information concerning a lacking pattern (for example, a lacking composition) to the determination unit 137.

(Determination Unit 138)

The determination unit 138 determines a photographing environment of a captured image to be used for relearning based on analysis results by the image analysis unit 135 and the pattern analysis unit 136. In the following explanation, in order to simplify the explanation, unless otherwise noted, a case in which the determination unit 138 determines a photographing environment based on an analysis result of a test image by the image analysis unit 135 is explained.

[Subject 400]

(Subject 400/Composition)

For example, the determination unit 138 determines compositions of the subject 400 and a captured image using at least one of object/material information, reflectance information of an object, and composition/scene information. At this time, the determination unit 138 may use band information or luminance histogram information.

The determination unit 138 determines the subject 400 using the object/material information. As explained above, the image analysis unit 135 recognizes an object or a material included in a test image with semantic segmentation.

The determination unit 138 determines the subject 400 based on the object and the material recognized by the image analysis unit 135. For example, the determination unit 138 determines, as the subject 400, the same object as the object recognized by the image analysis unit 135.

Here, a large object such as a car or a person includes various materials. Therefore, the determination unit 138 may limit the subject 400 using the material recognized by the image analysis unit 135. For example, when the image analysis unit 135 detects a ball made of plastic, the determination unit 138 determines, as the subject 400, a ball made of plastic instead of rubber even if the ball is the same.

Note that the determination unit 138 does not have to always determine, as the subject 400, the same object as the object recognized by the image analysis unit 135. For example, when it is difficult to photograph a large object such as a car in the studio (see FIG. 1), the determination unit 138 may determine a similar object such as a mini car or a model car as the subject 400.

The determination unit 138 may determine the subject 400 using the band information or the luminance histogram information. For example, the determination unit 138 determines, as the subject 400, an object (for example, a red car) having a similar color of a color of the object recognized by the image analysis unit 135 out of a plurality of objects (for example, cars). The band information or the luminance histogram information can be used as supplementary information in the determination of the subject 400 by the determination unit 138.

In this way, the determination unit 138 may determine, as the subject 400, the same object as the object recognized by the image analysis unit 135 or may determine, as the subject 400, a similar object having a similar color, a similar material, or a similar shape.

The determination unit 138 may increase accuracy of the material of the object using the reflectance information of the object. For example, even the same metal has different reflectance depending on a type. The determination unit 138 estimates a type (for example, aluminum, copper, or the like) of a material (for example, metal) recognized by the image analysis unit 135 from the reflectance of the object. The determination unit 138 can determine the subject 400 based on the estimated material type.

The determination unit 138 determines a position and a posture of the determined subject 400 and a composition of the captured image based on the composition information analyzed by the image analysis unit 135. For example, the determination unit 138 determines a relative positional relation between the subject 400 and the imaging apparatus 200 to be closer to the composition of the test image.

For example, the determination unit 138 determines a disposition position and a posture of the subject 400 in the studio from a current position a photographing direction, and the like of the imaging apparatus 200 in the studio (see FIG. 1). Alternatively, the determination unit 138 may determine a position, a direction, magnification, and the like of the imaging apparatus 200 from the position and the posture of the subject 400 in the studio.

(Motion of the Subject 400)

The determination unit 138 determines a motion of the subject 400 based on the motion information analyzed by the image analysis unit 135.

Based on the motion information, the determination unit 138 estimates whether the object included in the test image is moving or the imaging apparatus itself that has captured the test image is moving.

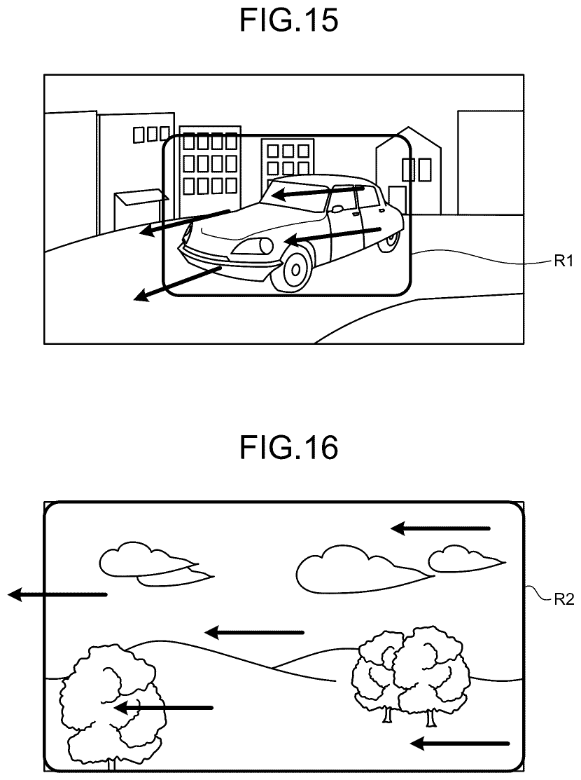

FIG. 15 and FIG. 16 are diagrams for explaining motion estimation by the determination unit 138 according to the embodiment of the present disclosure.

As illustrated in FIG. 15, when an object (for example, a car) included in the test image is moving, for example, a part of the test image surrounded by a rectangular frame R1 moves and the periphery of the test image does not move. When a motion of the object in the test image is different from a motion of the periphery, the determination unit 138 estimates that the object is moving.

As illustrated in FIG. 16, when the imaging apparatus captures the test image while moving, for example, an entire image surrounded by a rectangular frame R2 uniformly moves. When the entire test image uniformly moves, the determination unit 138 estimates that the imaging apparatus itself that has captured the test image is moving.

When estimating that the object is moving, the determination unit 138 determines that the subject 400 moves in the same manner as the estimated object. For example, when estimating that the object is moving, the determination unit 138 estimates a motion amount (moving speed of the object) a moving direction indicating how much and in which direction the object is moving in the test image. The determination unit 138 determines a moving direction and a distance of the subject 400 in a studio (see FIG. 1) based on a relative positional relation between the imaging apparatus 200 and the subject 400.

[Illumination Apparatus 300]

(Light Source Color and Intensity of the Light Source)

FIG. 3 is referred to again. The determination unit 138 estimates a light source color of the test image and intensity of the light source using the reflectance information and the light source information of the object.

For example, the determination unit 138 estimates intensity of the light source from the intensity and the degree of concentration of the specular component separated using the dichroic reflection model. The determination unit 138 estimates a light source color from a color of the specular component.

The determination unit 138 determines intensity and a color of the illumination apparatus 300 to emit light with the estimated intensity of the light source and the estimated light source color. For example, the determination unit 138 determines control parameters of the illumination apparatus 300 such that light reflected by the subject 400 has the estimated intensity of the light source and the estimated light source color. Note that the control parameters can be adjusted according to a relative distance between the illumination apparatus 300 and the subject 400 and a color of the subject 400.

(Direction of the Light Source)

The determination unit 138 estimates a direction of the light source in the test image using the reflectance information of the object and the light source information. For example, the determination unit 138 estimates the direction of the light source by statistically grasping a generation position of the specular component of the dichroic reflection model.

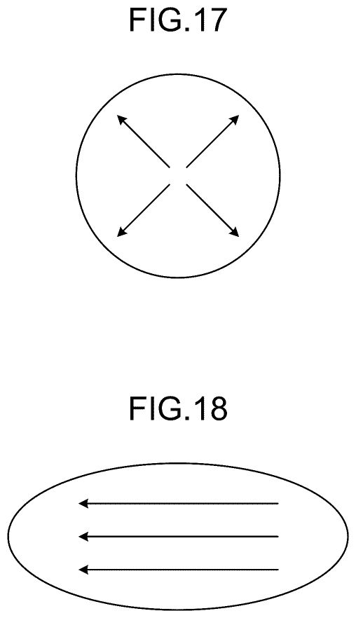

The direction estimation for the light source by the determination unit 138 is explained with reference to FIG. 17 and FIG. 18. FIG. 17 and FIG. 18 are diagrams for explaining direction estimation for the light source by the determination unit 138 according to the embodiment of the present disclosure. FIG. 17 and FIG. 18 illustrate a specular component of the object. Arrows illustrated in FIG. 17 and FIG. 18 indicate changes in the specular component. The specular component decreases toward the tips of the arrows.

As illustrated in FIG. 17, when the shape of the specular component of the object is close to a perfect circle and the intensity of the specular component gradually decreases from the vicinity of the center of the perfect circle, the determination unit 138 estimates that light strikes the object from the front (a position close to the imaging apparatus).

As illustrated in FIG. 18, when the shape of the specular component of the object is close to an ellipse and a reflection peak is not near the center of the ellipse, the determination unit 138 estimates that light strikes from the side of the object. More specifically, in this case, the determination unit 138 estimates that the light strikes from a direction in which the specular component is strong to a direction in which the specular component is weak. In an example illustrated in FIG. 18, the determination unit 138 estimates that light strikes from the right side of the object.

In this way, the determination unit 138 estimates the direction of the light source with respect to the object from the change in the shape and intensity of the specular component of the reflected light of the object.

The determination unit 138 determines a relative positional relation among the subject 400, the imaging apparatus 200, and the illumination apparatus 300 based on an estimation result.

For example, the determination unit 138 determines a position of the imaging apparatus 200 in the studio and a light irradiation direction based on a current position and a current posture of the subject 400 in the studio (see FIG. 1), a position and a photographing direction of the illumination apparatus 300 in the studio, and the like. Alternatively, the determination unit 138 may determine a position, a photographing direction, and the like of the imaging apparatus 200 from the position and the light irradiation direction of the illumination apparatus 300 in the studio, the position and the posture of the subject 00, and the like. Alternatively, the determination unit 138 may determine a position and a photographing direction of the illumination apparatus 300 from the position and the photographing direction of the imaging apparatus 200 in the studio, the position and the posture of the subject 00, and the like.

[Imaging Apparatus 200]

(Motion of the imaging apparatus 200)

FIG. 3 is referred to again. The determination unit 138 determines a motion of the imaging apparatus 200 based on the motion information analyzed by the image analysis unit 135.

As explained above, the determination unit 138 estimates, based on the motion information, whether the imaging apparatus has captured the test image while moving.

When estimating that the imaging apparatus has captured the test image while moving, the determination unit 138 determines a motion of the imaging apparatus 200 such that the imaging apparatus 200 moves in the same manner as the imaging apparatus used for capturing the test image. For example, when estimating that the imaging apparatus used to capture the test image is moving, the determination unit 138 estimates a motion amount (moving speed of the imaging apparatus) and a moving direction indicating how much and in which direction the imaging apparatus is moving at the test image capturing time. The determination unit 138 determines a moving direction and a distance of the imaging apparatus 200 in the studio (see FIG. 1) based on the relative positional relation between the imaging apparatus 200 and the subject 400.

(Aperture Value)

The determination unit 138 determines an aperture value (an F value) using the depth of field, the blur information, and the band information. For example, the determination unit 138 determines an F value of the imaging apparatus 200 such that the test image is in focus on the entire screen and the F value is larger as a blur degree is smaller. The determination unit 138 determines the F value of the imaging apparatus 200 such that a foreground extracted by the foreground/background separation detection is in focus and the F value is smaller as a blur degree of a background is larger.

(Shutter Speed)

The determination unit 138 determines shutter speed of the imaging apparatus 200 based on the motion information, the band information, and the like.

The determination unit 138 calculates a motion amount of the object from the motion vector included in the motion information and estimates a blur degree of a contour of the object from the band information, the blur information, and the like. The determination unit 138 determines shutter speed of the imaging apparatus 200 according to the motion amount of the object and the blur degree of the contour.

For example, the determination unit 138 determines the shutter speed of the imaging apparatus 200 such that the shutter speed is higher as the contour of the object is clearer with respect to the motion amount and the blur degree is smaller. The determination unit 138 determines the shutter speed of the imaging apparatus 200 such that the contour of the object is blurred with respect to the motion amount and the shutter speed is lower as the blur degree is larger.

(Iso Sensitivity)

The determination unit 138 determines ISO sensitivity of the imaging apparatus 200 based on the noise information and the luminance histogram information.

The determination unit 138 estimates a noise amount and brightness of the screen of the test image from the noise information and the luminance histogram information and determines the ISO sensitivity of the imaging apparatus 200 according to an estimation result.

For example, the determination unit 138 determines the ISO sensitivity of the imaging apparatus 200 such that the ISO sensitivity is higher as the entire screen of the test image is darker and has more noise and the ISO sensitivity is lower as the entire screen is brighter and has less noise.

Here, the determination unit 138 determines the photographing environment for capturing the captured image similar to the test image or the image of the pattern in short. However, the present disclosure is not limited thereto. Besides the photographing environment, the determination unit 138 may determine, for example, an environment in which a part of the photographing environment is changed. For example, the determination unit 138 may determine a motion different from the motion of the object in the test image as the motion of the subject 400. The determination unit 138 may determine a plurality of irradiation directions of the illumination apparatus 300, a plurality of motions of the imaging apparatus 200, and the like to determine a plurality of photographing environments.

In this way, the determination unit 138 sets the plurality of photographing environments based on the analysis result of the test image or the image of the pattern in short. Consequently, it is possible to increase patterns of captured images used in relearning. The information processing apparatus 100 can efficiently perform the relearning.

The determination unit 138 outputs information concerning the determined photographing environment to the setting unit 139.

(Setting Unit 139)

The setting unit 139 notifies information concerning the photographing environment determined by the determination unit 138 to the imaging apparatus 200, the illumination apparatus 300, and the user to set the photographing environment. Note that, when the setting of the subject 400 is automatically performed using a conveyance apparatus or the like instead of being performed by the user (a person), the setting unit 139 notifies information concerning the subject 400 to the conveyance apparatus or the like that performs the setting of the subject 400.

The setting unit 139 notifies, among the information concerning the photographing environment determined by the determination unit 138, information such as the aperture value, the shutter speed, and the ISO sensitivity to the imaging apparatus 200 as imaging setting information. The setting unit 139 notifies information such as the position, the imaging direction, the motion amount, and the direction of the imaging apparatus 200 to the imaging apparatus 200 as imaging driving setting information.

The setting unit 139 notifies, among the information concerning the photographing environment determined by the determination unit 138, information such as the intensity of the light source and the light source color to the illumination apparatus 300 as light source setting information. The setting unit 139 notifies information such as the position of the illumination apparatus 300 and the light irradiation (projection) direction to the illumination apparatus 300 as light source driving setting information.

The setting unit 139 notifies, among the information concerning the photographing environment determined by the determination unit 138, information for identifying the subject 400 such as a type, a size, and a color of the subject 400 and information such as disposition, a posture, and a motion of the subject 400 to the user. For example, the setting unit 139 causes a display (not illustrated) to display these kinds of information to notify the information to the user.

When the subject 400 that does not self-travel is moved, the subject 400 may be placed on a moving apparatus (not illustrated) such as a carriage to allow the subject 400 to move. In this case, the setting unit 139 notifies information such as a motion amount and a direction of the subject 400 to the moving apparatus. When the moving apparatus moves according to the notification, the subject 400 can move in the motion amount and the direction determined by the determination unit 138.

The information processing apparatus 100 according to the embodiment of the present disclosure determines a photographing environment for capturing a captured image similar to a test image having low evaluation of an inference result of a test image using an image conversion model, in other words, having low conversion accuracy by the image conversion model.

Consequently, the information processing apparatus 100 can more efficiently acquire a captured image that contributes to improvement in accuracy of image conversion processing.

The information processing apparatus 100 according to an embodiment of the present disclosure analyzes an initial learning data set used for initial learning and detects a pattern of an image in short in the initial learning data set. The information processing apparatus 100 determines a photographing environment for capturing a captured image similar to an image with a pattern in short.

Consequently, the information processing apparatus 100 can more efficiently acquire a captured image that contributes to improvement in accuracy of image conversion processing.

### 3. Expansion Processing

Subsequently, expansion processing executed by the information processing apparatus 100 according to the embodiment of the present disclosure is explained. The information processing apparatus 100 executes expansion processing (hereinafter also referred to as evaluation expansion processing) based on a test image with low evaluation and expansion processing (hereinafter also referred to as lack expansion processing) based on a pattern in short. The information processing apparatus 100 may individually execute the evaluation expansion processing and the insufficiency expansion processing, respectively or may simultaneously execute the evaluation expansion processing and the insufficiency expansion processing. The information processing apparatus 100 may execute either the evaluation expansion processing or the insufficiency expansion processing.

### 3.1. Evaluation Expansion Processing

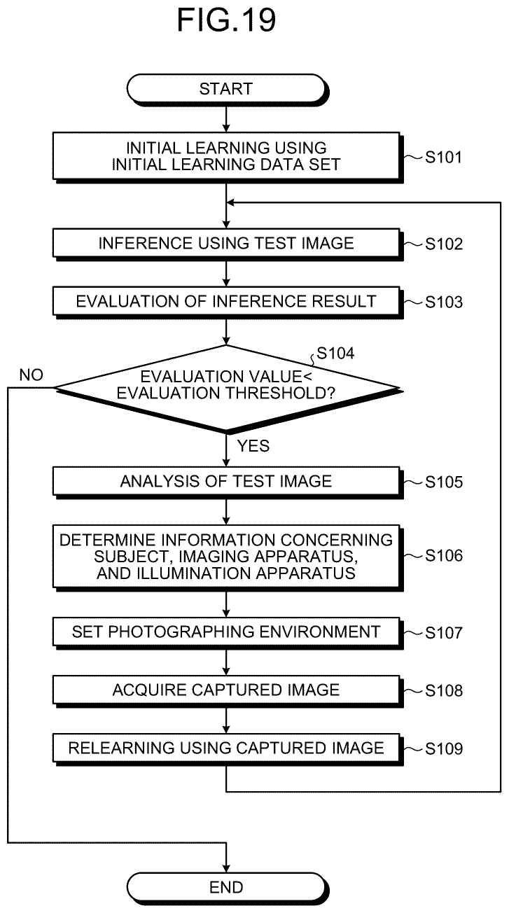

FIG. 19 is a flowchart illustrating a flow of an example of the evaluation expansion processing executed by the information processing apparatus 100 according to the embodiment of the present disclosure.

As illustrated in FIG. 19, the information processing apparatus 100 performs initial learning using the initial learning data set (step S101). The information processing apparatus 100 performs supervised learning using a Ground Truth image (teacher data) included in the initial learning data set and a deteriorated image (student data) obtained by deteriorating the Ground Truth image to generate an image conversion model.

Subsequently, the information processing apparatus 100 performs inference using the test image (step S102). The information processing apparatus 100 receives the test image as an input and obtains an output image using the image conversion model to perform inference.

The information processing apparatus 100 evaluates an inference result (step S103). The information processing apparatus 100 evaluates the output image obtained in step S102 based on a predetermined evaluation indicator to acquire an evaluation value. Examples of the evaluation indicator include general evaluation indicators such as PSNR, SSIM, and LIPS.

The information processing apparatus 100 decides whether the acquired evaluation value is smaller than a predetermined threshold (an evaluation threshold) (step S104). When the evaluation value is equal to or larger than the evaluation threshold (step S104; No), the information processing apparatus 100 determines that the accuracy of the image conversion model is desired accuracy and ends the evaluation expansion processing.

On the other hand, when the evaluation value is smaller than the evaluation threshold (step S104; Yes), the information processing apparatus 100 decides that the evaluation of the test image is low and relearning is performed and analyzes the test image.

The information processing apparatus 100 determines, based on an analysis result, information concerning the subject 400, the imaging apparatus 200, and the illumination apparatus 300 (step S105).

The information processing apparatus 100 sets, based on the determined information, a photographing environment in which a captured image to be used for relearning is captured (step S107).

The information processing apparatus 100 acquires the captured image captured in the set photographing environment (step S108).

The information processing apparatus 100 performs relearning using the acquired captured image (step S109). The information processing apparatus 100 performs supervised learning using the acquired captured image in addition to the initial learning data set to update the image conversion model. At this time, the information processing apparatus 100 sets the captured image as a Ground Truth image and sets, as a deterioration image, an image obtained by deteriorating the captured image to perform relearning. Thereafter, the information processing apparatus 100 returns to step S102.

Note that the information processing apparatus 100 can perform inference and evaluation targeting one or more test images. Here, when inference and evaluation for n (n is a natural number equal to or larger than 2) test images are performed, the information processing apparatus 100 compares, for example, evaluation values of the n test images and an evaluation threshold. When the number of test images, evaluation values of which are smaller than the evaluation threshold, is m (m is a natural number satisfying m<n), the information processing apparatus 100 decides to perform relearning and analyzes the test images, the evaluation values of which are smaller than the evaluation threshold.

### 3.2. Lack Expansion Processing

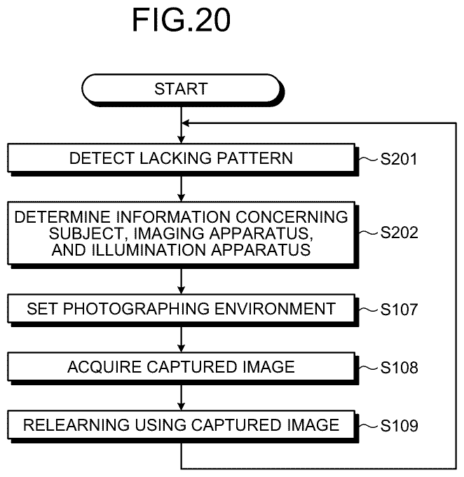

FIG. 20 is a flowchart illustrating a flow of an example of lack expansion processing executed by the information processing apparatus 100 according to the embodiment of the present disclosure.

First, the information processing apparatus 100 detects an image pattern (a lacking pattern) that is lacking from the initial learning data set (step S201).

Subsequently, the information processing apparatus 100 determines information concerning the subject 400, the imaging apparatus 200, and the illumination apparatus 300 in order to perform imaging with the lacking pattern (step S202).

In the following explanation, the setting of the photographing environment (step S107) and the acquisition of the captured image (step S108) using the determined information are the same as those in the evaluation expansion processing explained above. Therefore, explanation thereof is omitted.

After acquiring the captured image (step S108), the information processing apparatus 100 ends the processing.

Note that the information processing apparatus 100 may execute the lack expansion processing prior to the evaluation expansion processing or may execute the lack expansion processing simultaneously with the evaluation expansion processing. For example, when performing the lack expansion processing prior to the evaluation expansion processing, the information processing apparatus 100 includes, in the initial learning data set, the captured image acquired in the lack expansion processing to perform the initial learning. On the other hand, when executing the lack expansion processing simultaneously with the evaluation expansion processing, the information processing apparatus 100 detects a lack pattern in step S201 of the lack expansion processing in parallel to or continuously from the analysis of the test image performed in step S105 of the evaluation expansion processing.

Alternatively, the information processing apparatus 100 can execute the lack expansion processing after the evaluation expansion processing. In this case, the information processing apparatus 100 may detect a lack pattern from the initial learning data set and the captured image used for the relearning.

### 4. Other Embodiments

The embodiment explained above indicate an example and various changes and applications are possible.

In the embodiment explained above, the information processing apparatus 100 performs the relearning using the captured image. However, the present disclosure is not limited thereto. The information processing apparatus 100 may perform the relearning using, for example, control parameters of the imaging apparatus 200 as well.

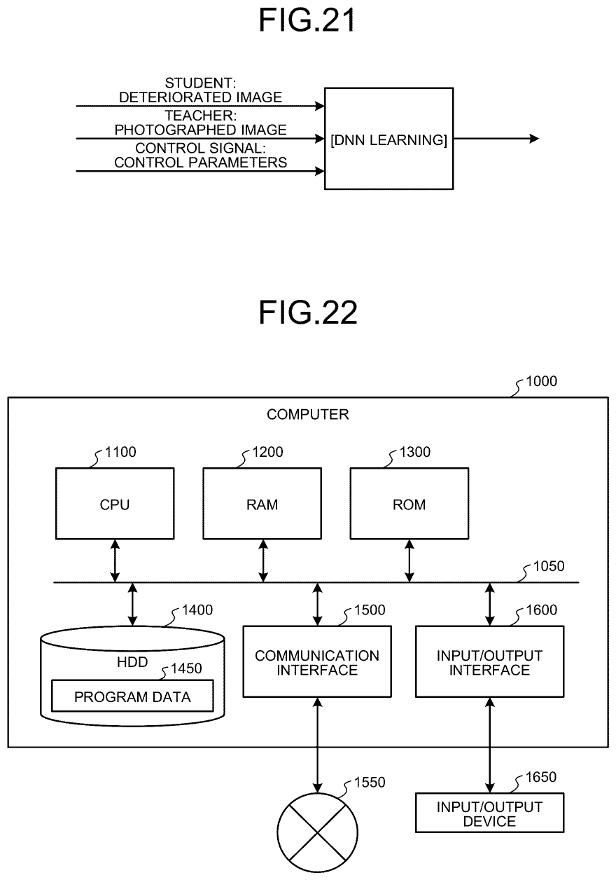

FIG. 21 is a diagram for describing another example of the relearning by the information processing apparatus 100 according to the embodiment of the present disclosure.

As illustrated in FIG. 21, the information processing apparatus 100 receives a control parameter as an input in addition to a captured image (teacher) and a deteriorated image (student) obtained by deteriorating the captured image and performs DNN learning to generate an image conversion model.

As explained above, the information processing apparatus 100 sets the photographing environment of the captured image. Therefore, the information processing apparatus 100 grasps control parameters of the imaging apparatus 200 at the time of capturing of the captured image. Therefore, the information processing apparatus 100 can perform specialized processing by the control parameters when performing learning. That is, the information processing apparatus 100 can perform conditional prediction using the control parameters of the imaging apparatus 200 as a control signal.

In this way, in the image processing by the DNN, learning by an image group photographed by the target imaging apparatus 200 (for example, a camera or a smartphone) is possible. Therefore, the information processing apparatus 100 is capable of constructing a DNN network (an image conversion model) based on characteristics of the imaging apparatus 200 and can improve accuracy of image processing.

In the embodiment explained above, the user performs the setting of the subject 400 and the lighting by the illumination apparatus 300 and the imaging by the imaging apparatus 200 are automatically performed. However, the present disclosure is not limited thereto.

For example, the user may perform the setting the photographing environment and the capturing of the captured image. For example, the user performs the setting of the subject 400 and the setting of the imaging apparatus 200 and the illumination apparatus 300 according to a notification of the information processing apparatus 100 and performs the capturing of the captured image.

Since the user performs the imaging, the information processing apparatus 100 can acquire the captured image with a simpler system. Since the imaging is performed in the photographing environment determined by the information processing apparatus 100, the information processing apparatus 100 can efficiently acquire a captured image to be used for relearning without being affected by knowledge or experience of the user.

Note that a range of the setting performed by the information processing apparatus 100 can be changed as appropriate, for example, the user performs the setting and the imaging of the subject 400 and the information processing apparatus 100 performs the setting of the imaging apparatus 200 and the illumination apparatus 300.

In the embodiment explained above, the information processing apparatus 100 performs the relearning using the captured image captured by the imaging apparatus 200. However, the present disclosure is not limited thereto. For example, the information processing apparatus 100 may perform the relearning using a combined image obtained by combining a background with the subject 400 imaged by the imaging apparatus 200. In this way, an image to be relearned may include an image obtained by applying image processing such as combination to the captured image captured by the imaging apparatus 200.

### 5. Application Examples

The setting of the photographing environment explained above in the embodiment can be used for automatic setting of a photographing environment in video production.

For example, by analyzing a simple image (for example, a CG image) desired to be captured created in video production of a movie, a drama, or the like, the information processing apparatus 100 can determine a photographing environment for photographing a video similar to the image. Consequently, the user can automatically determine a photographing environment for photographing a desired video only by generating a simple image. Note that setting of photographing of a moving image can be easily performed by setting motions of the subject 400 and the imaging apparatus 200.

The setting of the photographing environment explained above in the embodiment can also be applied to a product in which image processing by an image conversion model (for example, a DNN network) is already incorporated.

In the embodiment explained above, the information processing apparatus 100 analyzes the test image with low evaluation and the imaging apparatus 200 captures the Ground Truth image serving as the teacher data.

The information processing apparatus 100 may analyze a test image with high evaluation. The information processing apparatus 100 analyzes, for example, a test image having an evaluation value equal to or higher than a predetermined threshold and sets a photographing environment based on an analysis result.

Since the information processing apparatus 100 analyzes the test image with high evaluation, an effect of the image processing by the image conversion model loaded in the product is high, that is, a test image matching the image processing can be analyzed.

Since the information processing apparatus 100 determines the photographing environment based on the analysis result of the test image with high evaluation, the imaging apparatus 200 can perform imaging in an environment further matching the image processing by the image conversion model loaded in the product.

### 6. Hardware Configuration

The information processing apparatus 100 according to the embodiment explained above is implemented by, for example, a computer 1000 having a configuration as illustrated in FIG. 22. FIG. 22 is a hardware configuration diagram illustrating an example of the computer 1000 that implements the functions of the information processing apparatus 100. The computer 1000 includes a CPU 1100, a RAM 1200, a ROM 1300, a storage 1400, a communication interface 1500, and an input/output interface 1600. The units of the computer 1000 are connected by a bus 1050.

The CPU 1100 operates based on programs stored in the ROM 1300 or the storage 1400 and controls the units. For example, the CPU 1100 loads, in the RAM 1200, the programs stored in the ROM 1300 or the storage 1400 and executes processing corresponding to various programs. Alternatively, the functions of the information processing apparatus 100 may be executed by a processor such as a not-illustrated GPU (Graphics Processing Unit) instead of the CPU 1100. In this case, for example, a part of functions (for example, learning and inference the DNN) of the information processing apparatus 100 may be performed by the GPU and other functions (for example, analysis) may be performed by the CPU 1100. Like the CPU 1100, the GPU also operates based on the programs stored in the ROM 1300 or the storage 1400 and controls the units. For example, the GPU loads, in the RAM 1200, the programs stored in the ROM 1300 or the storage 1400 and executes processing corresponding to various programs.

The ROM 1300 stores a boot program such as a BIOS (Basic Input Output System) executed by the CPU 1100 at a start time of the computer 1000, a program depending on hardware of the computer 1000, and the like.

The storage 1400 is a computer-readable recording medium that non-transiently records a program to be executed by the CPU 1100, data used by the program, and the like. Specifically, the storage 1400 is a recording medium that records a program according to the present disclosure that is an example of the program data 1450.

The communication interface 1500 is an interface for the computer 1000 to be connected to an external network 1550. For example, the CPU 1100 receives data from other equipment and transmits data generated by the CPU 1100 to the other equipment via the communication interface 1500.

The input/output interface 1600 is an interface for connecting an input/output device 1650 and the computer 1000. For example, the CPU 1100 is capable of receiving data from an input device such as a keyboard, a mouse, or an acceleration sensor 13 via the input/output interface 1600. The CPU 1100 is capable of transmitting data to an output device such as a display, a speaker, or a printer via the input/output interface 1600. The input/output interface 1600 may function as a media interface that reads a program or the like recorded in a predetermined recording medium (a medium). The medium is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 1000 functions as the information processing apparatus 100 according to the embodiment, the CPU 1100 of the computer 1000 realizes the function of the control unit 130 by executing the information processing program loaded on the RAM 1200. The program according to the present disclosure and data in the storage unit 120 are stored in the storage 1400. Note that the CPU 1100 reads the program data 1450 from the storage 1400 and executes the program data 1450. However, as another example, the CPU 1100 may acquire these programs from another device via the external network 1550.

### 7. Summary

The preferred embodiment of the present disclosure is explained in detail above with reference to the accompanying drawings. However, the technical scope of the present disclosure is not limited to such an example. It is evident that those having the ordinary knowledge in the technical field of the present disclosure can arrive at various alterations or corrections within the category of the technical idea described in claims. It is understood that these alterations and corrections naturally belong to the technical scope of the present disclosure.

Among the processing explained in the above embodiments, all or a part of the processing explained as being automatically performed can be manually performed or all or a part of the processing explained as being manually performed can be automatically performed by a publicly-known method. Besides, the processing procedure, the specific names, and the information including the various data and parameters described in the document and the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like.

The embodiments explained above can be combined as appropriate within a range in which the processing contents do not contradict one another.

The effects described in this specification are only explanatory or illustrative and are not limiting. That is, the technique according to the present disclosure can achieve other effects obvious to those skilled in the art from the description of this specification together with the effects or instead of the effects.

Note that the following configurations also belong to the technical scope of the present disclosure.

(1)

An information processing apparatus comprising:
a generation unit that performs supervised learning using first image data and teacher data and generates an image conversion model;
a conversion unit that generates converted data from second image data using the image conversion model;
an evaluation unit that evaluates the converted data;
an image analysis unit that analyzes the second image data corresponding to the converted data, evaluation of which by the evaluation unit is lower than a predetermined standard; and
a determination unit that determines, based on an analysis result by the image analysis unit, a photographing environment of photographing performed to acquire the teacher data.
   (2)

The information processing apparatus according to (1), wherein the generation unit performs relearning using the teacher data photographed in the photographing environment determined by the determination unit.

(3)

The information processing apparatus according to (1) or (2), further comprising
a pattern analysis unit that analyzes an imaging pattern of at least one of the first image data and the teacher data, wherein
the determination unit determines the photographing environment based on an analysis result by the pattern analysis unit.
   (4)

The information processing apparatus according to any one of (1) to (3), wherein the conversion unit applies super-resolution processing or HDR conversion processing to the second image data using the image conversion model to generate the converted data.

(5)

The information processing apparatus according to any one of (1) to (4), wherein the first image data is an image obtained by deteriorating the teacher data.

(6)

The information processing apparatus according to any one of (1) to (5), wherein the photographing environment includes at least one of kinds of information concerning an imaging apparatus, an illumination apparatus, and a subject used in the photographing.

(7)

The information processing apparatus according to (6), wherein
the image analysis unit analyzes at least one of an object, a material, reflectance, and a composition of the object, and a scene included in the second image data, and
the determination unit determines at least one of the subject, a position of the subject, and a direction of the subject.
   (8)

The information processing apparatus according to (6) or (7), wherein
the image analysis unit analyzes a motion of an object included in the second image data, and
the determination unit determines at least one of a motion of the subject and a motion of the imaging apparatus.
   (9)

The information processing apparatus according to any one of (6) to (8), wherein
the image analysis unit analyzes at least one of a reflectance of an object, a light source, and a color histogram included in the second image data, and
the determination unit determines at least one of intensity, a color, a direction, and a motion of the illumination apparatus.
   (10)

The information processing apparatus according to any one of (6) to (9), wherein
the image analysis unit analyzes at least one of kinds of information concerning a depth of field, a blur, and a band of the second image data, and
the determination unit determines an aperture value of the imaging apparatus.
   (11)

The information processing apparatus according to any one of (6) to (11), wherein
the image analysis unit analyzes at least one of kinds of information concerning a motion of an object included in the second image data and a band of the second image data, and
the determination unit determines shutter speed of the imaging apparatus.
   (12)

The information processing apparatus according to any one of (6) to (11), wherein
the image analysis unit analyzes at least one of a noise amount and a luminance histogram of the second image data, and
the determination unit determines at least one of ISO sensitivity and a white balance of the imaging apparatus.
   (13)

An information processing system comprising:
an information processing apparatus including:
a generation unit that performs supervised learning using first image data and teacher data and generates an image conversion model;
a conversion unit that generates converted data from second image data using the image conversion model;
an evaluation unit that evaluates the converted data;
an image analysis unit that analyzes the second image data corresponding to the converted data, evaluation of which by the evaluation unit is lower than a predetermined standard; and
a determination unit that determines, based on an analysis result by the image analysis unit, a photographing environment of photographing performed to acquire the teacher data; and
an imaging apparatus that performs imaging in the photographing environment.
   (14)

An information processing method comprising:
performing supervised learning using first image data and teacher data and generating an image conversion model;
generating converted data from second image data using the image conversion model;
evaluating the converted data;
analyzing the second image data corresponding to the converted data, evaluation of which is lower than a predetermined standard; and
determining, based on an analysis result of the second image data, a photographing environment of photographing performed to acquire the teacher data.
   (15)

A program for causing an information processing apparatus to execute processing of:
performing supervised learning using first image data and teacher data and generate an image conversion model;
generating converted data from second image data using the image conversion model;
evaluating the converted data;
analyzing the second image data corresponding to the converted data, evaluation of which is lower than a predetermined standard; and
determining, based on an analysis result of the second image data, a photographing environment of photographing performed to acquire the teacher data.

### REFERENCE SIGNS LIST

10 INFORMATION PROCESSING SYSTEM
100 INFORMATION PROCESSING APPARATUS
110 COMMUNICATION UNIT
120 STORAGE UNIT
130 CONTROL UNIT
131 ACQUISITION UNIT
132 LEARNING UNIT
133 INFERENCE UNIT
134 EVALUATION UNIT
135 IMAGE ANALYSIS UNIT
136 PATTERN ANALYSIS UNIT
137 DECISION UNIT
138 DETERMINATION UNIT
139 SETTING UNIT
200 IMAGING APPARATUS
210 IMAGING UNIT
220 IMAGING CONTROL UNIT
230 IMAGING DRIVING UNIT
240 IMAGING DRIVING CONTROL UNIT
300 ILLUMINATION APPARATUS
310 LIGHT SOURCE
320 LIGHT SOURCE CONTROL UNIT
330 LIGHT SOURCE DRIVING UNIT
340 LIGHT SOURCE DRIVING CONTROL UNIT
400 SUBJECT

1. An information processing apparatus comprising:
a generation unit that performs supervised learning using first image data and teacher data and generates an image conversion model;
a conversion unit that generates converted data from second image data using the image conversion model;
an evaluation unit that evaluates the converted data;
an image analysis unit that analyzes the second image data corresponding to the converted data, evaluation of which by the evaluation unit is lower than a predetermined standard; and
a determination unit that determines, based on an analysis result by the image analysis unit, a photographing environment of photographing performed to acquire the teacher data.

2. The information processing apparatus according to claim 1, wherein the generation unit performs relearning using the teacher data photographed in the photographing environment determined by the determination unit.

3. The information processing apparatus according to claim 1, further comprising
a pattern analysis unit that analyzes an imaging pattern of at least one of the first image data and the teacher data, wherein
the determination unit determines the photographing environment based on an analysis result by the pattern analysis unit.

4. The information processing apparatus according to claim 1, wherein the conversion unit applies super-resolution processing or HDR conversion processing to the second image data using the image conversion model to generate the converted data.

5. The information processing apparatus according to claim 1, wherein the first image data is an image obtained by deteriorating the teacher data.

6. The information processing apparatus according to claim 1, wherein the photographing environment includes at least one of kinds of information concerning an imaging apparatus, an illumination apparatus, and a subject used in the photographing.

7. The information processing apparatus according to claim 6, wherein
the image analysis unit analyzes at least one of an object, a material, reflectance, and a composition of the object, and a scene included in the second image data, and
the determination unit determines at least one of the subject, a position of the subject, and a direction of the subject.

8. The information processing apparatus according to claim 6, wherein
the image analysis unit analyzes a motion of an object included in the second image data, and
the determination unit determines at least one of a motion of the subject and a motion of the imaging apparatus.

9. The information processing apparatus according to claim 6, wherein
the image analysis unit analyzes at least one of a reflectance of an object, a light source, and a color histogram included in the second image data, and
the determination unit determines at least one of intensity, a color, a direction, and a motion of the illumination apparatus.

10. The information processing apparatus according to claim 6, wherein
the image analysis unit analyzes at least one of kinds of information concerning a depth of field, a blur, and a band of the second image data, and
the determination unit determines an aperture value of the imaging apparatus.

11. The information processing apparatus according to claim 6, wherein
the image analysis unit analyzes at least one of kinds of information concerning a motion of an object included in the second image data and a band of the second image data, and
the determination unit determines shutter speed of the imaging apparatus.

12. The information processing apparatus according to claim 6, wherein
the image analysis unit analyzes at least one of a noise amount and a luminance histogram of the second image data, and
the determination unit determines at least one of ISO sensitivity and a white balance of the imaging apparatus.

13. An information processing system comprising:
an information processing apparatus including:
a generation unit that performs supervised learning using first image data and teacher data and generates an image conversion model;
a conversion unit that generates converted data from second image data using the image conversion model;
an evaluation unit that evaluates the converted data;
an image analysis unit that analyzes the second image data corresponding to the converted data, evaluation of which by the evaluation unit is lower than a predetermined standard; and
a determination unit that determines, based on an analysis result by the image analysis unit, a photographing environment of photographing performed to acquire the teacher data; and
an imaging apparatus that performs imaging in the photographing environment.

14. An information processing method comprising:
performing supervised learning using first image data and teacher data and generating an image conversion model;
generating converted data from second image data using the image conversion model;
evaluating the converted data;
analyzing the second image data corresponding to the converted data, evaluation of which is lower than a predetermined standard; and
determining, based on an analysis result of the second image data, a photographing environment of photographing performed to acquire the teacher data.

15. A program for causing an information processing apparatus to execute processing of:
performing supervised learning using first image data and teacher data and generate an image conversion model;
generating converted data from second image data using the image conversion model;
evaluating the converted data;
analyzing the second image data corresponding to the converted data, evaluation of which is lower than a predetermined standard; and
determining, based on an analysis result of the second image data, a photographing environment of photographing performed to acquire the teacher data.
